(19) United States
(12) Patent Application Publication
(10) Pub. No.: US 2015/0103668 A1
(43) Pub. Date: Apr. 16, 2015

(54) LOW OVERHEAD AND HIGHLY ROBUST FLOW CONTROL APPARATUS AND METHOD

(71) Applicants: Zhixin Tian, Shanghai (CN); Yunfeng He, Shanghai (CN)

(72) Inventors: Zhixin Tian, Shanghai (CN); Yunfeng He, Shanghai (CN)

(73) Assignee: Qualcomm Incorporated, San Diego, CA (US)

(21) Appl. No.: 14/399,942

(22) PCT Filed: Jun. 27, 2012
(86) PCT No.: PCT/CN2012/077601

§ 371 Date: Nov. 7, 2014

(51) Int. Cl. H04W 28/12; H04L 12/861

(52) U.S. Cl. CPC H04W 28/12; H04L 49/90
USPC 370/236

(57) ABSTRACT

A method and apparatus of controlling the flow of data transmitted from a transmitter to a receiver is disclosed. In a first mode, the method involves calculating an available buffer capacity based on buffer output information sent by the receiver to the transmitter. Data is transmitted from the transmitter to the receiver at a rate based on the calculated available buffer capacity. Upon detecting a threshold condition, the method switches to a second mode. The second mode involves sending transmit data in formation to the receiver, and updating the buffer output information based on the transmit data information.

### TECHNICAL FIELD

The present embodiments relate generally to data communications, and more particularly to methods and apparatus that provide flow control for buffering data.

### BACKGROUND OF RELATED ART

Data networks often rely on flow control networks to avoid overflowing receive side buffer circuits. The buffer provides a dynamic way to absorb and handle the ebb and flow of data being communicated between transmit and receive integrated circuits (ICs). A variety of solutions exist to address the flow control problem.

One known credit-based solution provides a backchannel from the receiver IC to the transmitter IC, or sender. The transmitter IC includes a transmit counter that tracks the amount of transmitted data from the transmitter IC while a forward counter on the receiver IC tracks the amount of data forwarded from the receiver IC. The receiver IC periodically sends a control signal indicating when the receive buffer empties (“forwards”) a certain amount of data, such as an aggregate number of bits, bytes, packets or symbols. Knowing the rate at which data is forwarded from the buffer with respect to the transmitted data count allows the sender to calculate the remaining buffer storage space. Unfortunately, relying solely on such a solution often involves a prohibitively large buffer, and a relatively low buffer utilization rate. Moreover, relying solely on the control signal may be problematic if the signal is susceptible to noise and false or missed detections.

Another known method employs a first counter at the sender to track the amount of transmit data sent to the receiver IC, and a second counter at the buffer that tracks the data it receives. An additional counter monitors a data count for data forwarded from the buffer and sends the count to the transmitter IC. The transmitter IC can track the remaining buffer space through straightforward calculations based on the transmit count and the forward count. Periodically, the transmit count is sent to the receiver IC to minimize any errors propagating over time due to dropped data packets. While this solution allows for the use of a smaller buffer, and corrects for lost data, the overhead in transmitting multiple bits from the buffer to the sender during normal operation undesirably occupies channel bandwidth.

### SUMMARY

A method and apparatus for controlling the flow of data transmitted from a transmitter IC to a receiver IC having a buffer is disclosed. The method involves, in a first mode, calculating available buffer capacity by the transmitter IC based on buffer output information sent by the receiver IC. Data is transmitted from the transmitter IC to the receiver IC at a rate based on the calculated available buffer capacity. Upon detecting a threshold event or condition, a second mode of operation is initiated that includes sending transmit data information to the receiver IC, and updating the buffer output information based on the transmit data information.

### BRIEF DESCRIPTION OF THE DRAWINGS

The present embodiments are illustrated by way of example and are not intended to be limited by the figures of the accompanying drawings, where:

FIG. 1 is a block diagram of one embodiment of a transmit integrated circuit communicating data to a receiver integrated circuit;

FIG. 2a is an illustrative flow chart depicting an exemplary method corresponding to the incremental and synchronization modes;

FIG. 2b illustrates a flow chart that includes further detailed steps corresponding to the synchronization mode step of FIG. 2a;

FIG. 3 illustrates a block diagram depicting a general data and information flow for the incremental mode of operation consistent with the method steps shown in FIG. 2a; and

FIG. 4 illustrates a block diagram depicting a general data and information flow for the synchronization mode of operation consistent with the method steps shown in FIG. 2b.

### DETAILED DESCRIPTION

In accordance with the present embodiments, a method and apparatus of controlling the flow of data transmitted from a transmitter IC to a receiver IC is disclosed. In a first mode, the method involves calculating an available buffer capacity based on buffer output information sent by the receiver IC to the transmitter IC. Data is transmitted from the transmitter IC to the receiver IC at a rate based on the calculated available buffer capacity. Upon detecting a threshold condition, the method switches to a second mode. The second mode involves sending transmit data information to the receiver IC, and updating the buffer output information based on the transmit data information.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

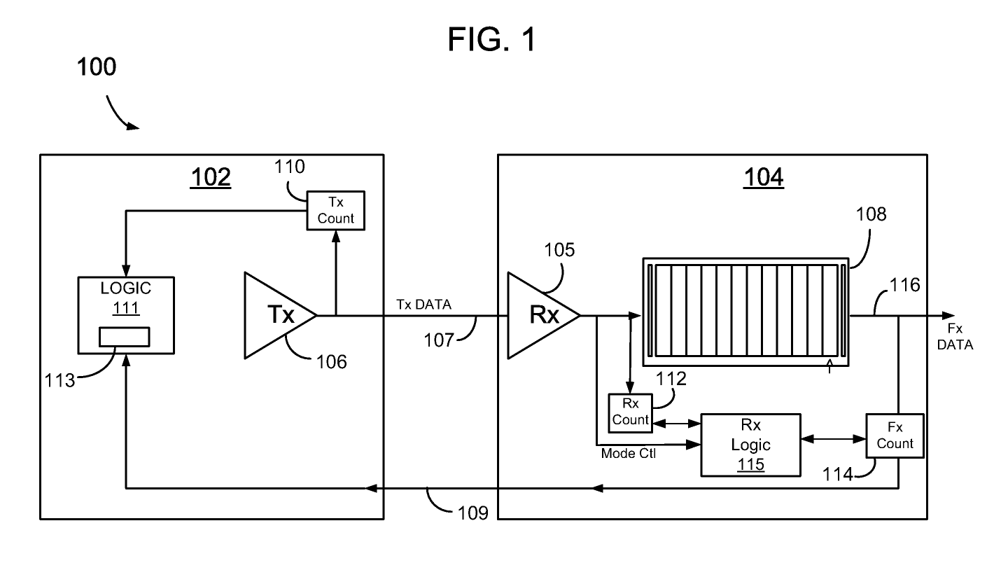

More specifically, and referring generally to FIG. 1, a signaling system 100 in accordance with one embodiment employs a transmitter integrated circuit (IC), or sender, in the form of a first processing unit 102 to direct data from a transmitter circuit 106 to a receiver IC in the form of a second processing unit 104. The processing units 102 and 104 may be general purpose CPUs, network processors, or the like that are interconnected via a signaling path 107 to effect a peer-to-peer network or direct connection therebetween. A second signaling path 109 provides a backchannel or feedback path between the processing units 102 and 104. While FIG. 1 illustrates separate unidirectional transmit and backchannel paths, in some embodiments, the signaling path 107 and signaling path 109 may be realized as a single bidirectional channel.

Further referring to FIG. 1, the first processing unit 102 includes a transmit counter 110 that monitors the amount of data being transmitted by the transmit circuit 106 over the signaling path 107 over a given interval of time. The transmit counter 110 receives a copy of the data transmitted by the transmit circuit 106 and may be configured to count a number of data packets, data bytes, data bits, or data in other formats output by the transmitter circuit 106. The count is fed to a logic circuit 111 which uses the count to predict an available buffer capacity at the second processing unit 104 as more fully described below.

In one embodiment, the logic circuit 111 includes error detection circuitry 113 capable of evaluating whether information received from the second processing unit 104 includes errors above a predefined error threshold. As more fully described below, detection of errors above the threshold may give rise to an event that initiates a change in operating modes.

The second processing unit 104 includes a receiver circuit 105 that receives the transmitted data Tx DATA from the transmit circuit 106 via the signaling path 107. A receive counter 112 generates a count that represents the amount of data received at the receiver circuit 105 similar to the manner in which the transmit counter 110 counts the transmit data. Receiver logic 115 disposed on the processing unit 104 monitors the receive count and is responsive to one or more control signals Mode Ctl from the transmitter IC 102 (through receiver circuit 105) to place the processing unit 104 into a second mode of operation, as more fully described below.

Further referring to FIG. 1, the output of the receiver circuit 105 feeds the received data to the input of a buffer circuit 108. The buffer circuit 108 may take the form of a first-in-first-out (FIFO) buffer, a circular or ring buffer, or the like, depending on the application. The buffer circuit 108 has a predetermined storage capacity and includes an output 116 that forwards the buffered data Fx DATA to a subsequent network node (not shown). A forwarding data counter 114 generates a count of buffered data as it is forwarded in a similar manner as the transmit and receive counters 110 and 112, respectively, and feeds the count back to the first processing unit 102 along the backchannel 109.

In one embodiment, the processing units 102 and 104 each include transceiver circuitry (not shown) such that the processing unit 102 includes both a transmitter circuit and a receiver circuit, and the processing unit 104 includes both a receiver circuit and a transmitter circuit.

In operation, the signaling system 100 may function in accordance with a plurality of modes in order to minimize the buffer size while maximizing bandwidth performance and reliability. Generally, this may be accomplished by running the system in an “incremental” mode of operation a majority of the time such that the transmitter IC is able to track the buffer usage with reasonable accuracy and minimal backchannel bandwidth. Upon the occurrence of one or more predefined types of events, where the perceived buffer availability may be susceptible to inaccuracies, a synchronization mode of operation may be initiated to reset the system and compensate for any errors that may have occurred during the incremental mode. Once the synchronization mode finishes updating the various operating parameters, operation of the system may resume in the incremental mode.

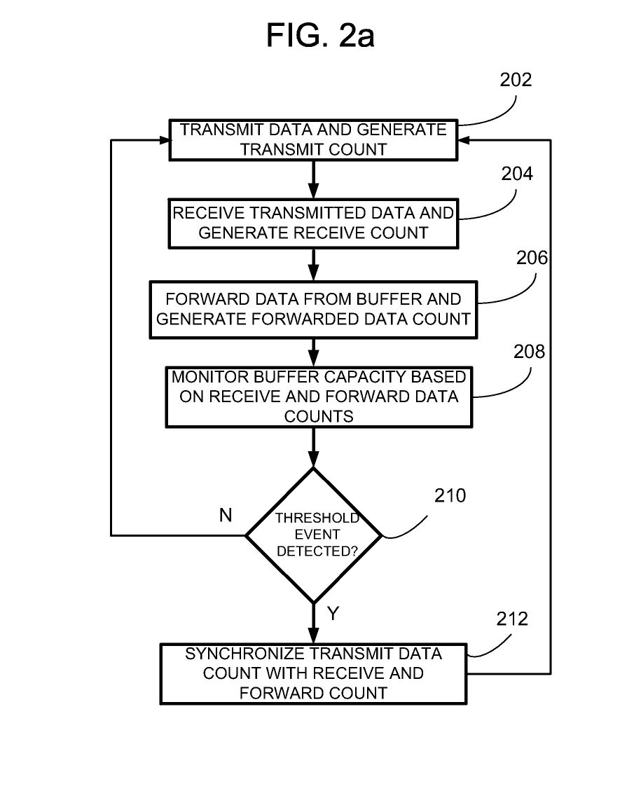

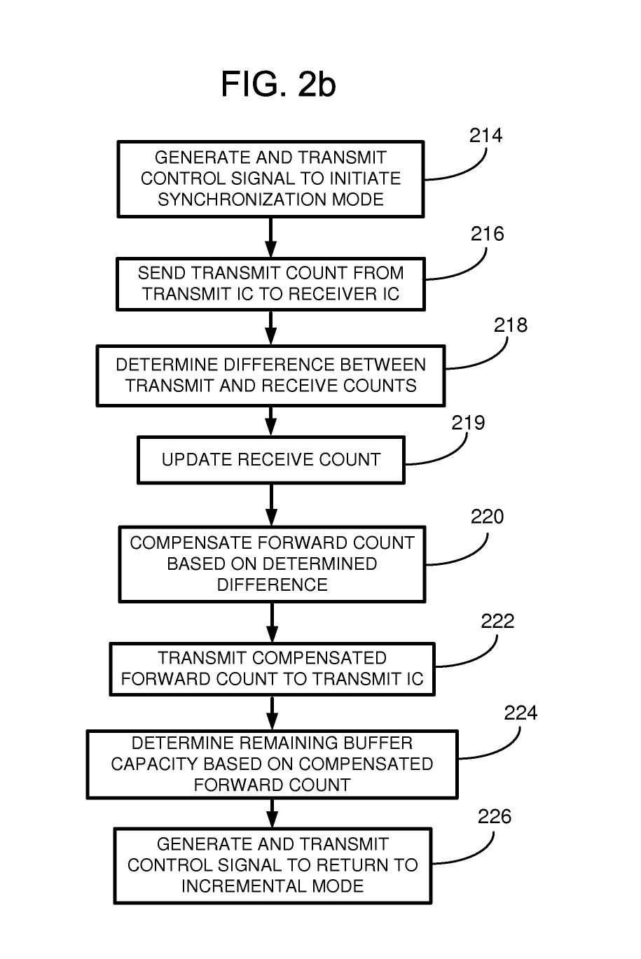

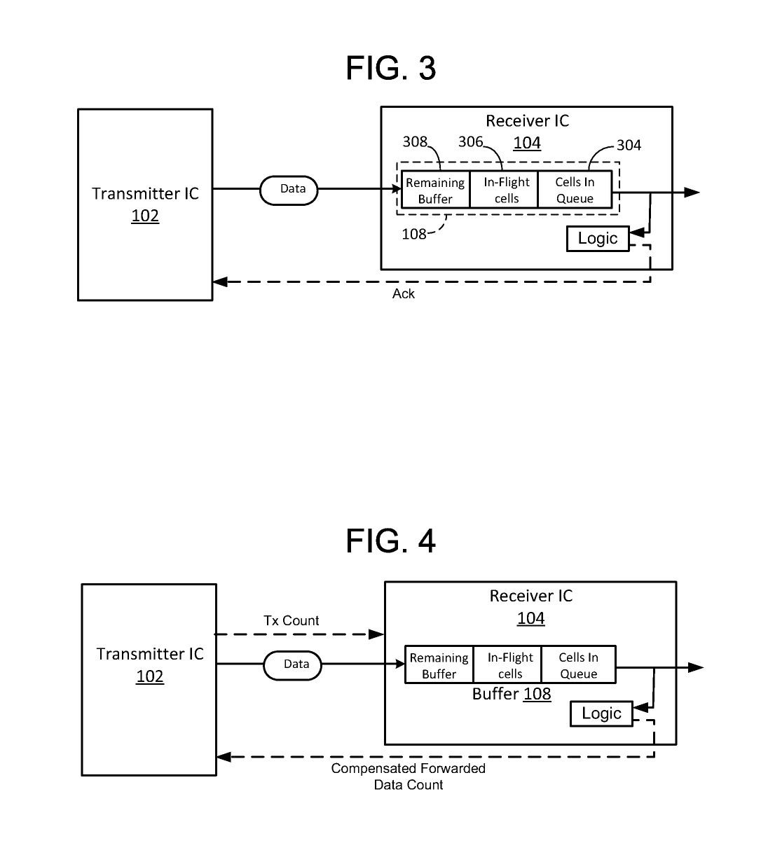

FIG. 2a illustrates a flowchart of steps that sets out a method of operation that employs the multiple modes, with a focus on the detailed steps associated with the incremental mode. FIG. 3 complements the steps of FIG. 2a by illustrating a block diagram of the data and information flow corresponding to operation in the incremental mode. The synchronization mode is represented as a step in FIG. 2a, but is set forth in further detail in FIG. 2b. FIG. 4 supplements the steps of FIG. 2b by illustrating a block diagram of the data and information flow corresponding to operation in the synchronization mode.

Referring to FIG. 2a and FIG. 3, the incremental mode of operation may provide a way to manage buffer utilization with minimal bandwidth allocated to the backchannel, thereby maximizing channel performance. The incremental mode may employ a credit-based approach to managing buffer utilization and flow. The buffer circuit 108, with its predefined capacity, at any given time may generally have a certain number of storage cells occupied by previously stored or queued data, represented by 304. Similarly, a certain number of the buffer storage locations may be allocated to data cells that are “in-flight”, represented by block 306. The difference between the queued and in-flight cells may represent the remaining buffer capacity, represented by block 308. Generally, the remaining buffer capacity is tracked, in the incremental mode, by periodically sending a control signal “Ack” from the receiver IC 104 to the transmitter IC 102 as data of a predefined size or granularity is forwarded from the output of the buffer circuit 108. The granularity criteria may be expressed in terms of bits, bytes, packets, or symbols, depending on the application.

To track the buffer capacity in the incremental mode, and referring primarily to FIG. 2a, the transmitter IC 102 transmits data and utilizes the transmit counter 110 to generate a transmit count, at 202. The transmit count represents the amount of data transmitted from the transmitter IC 102, referenced from a predefined starting point, such as the start of a new incremental mode cycle. The receiver IC 104 employs the receive counter 112 to generate a receive count, at 204, representing the data received from the transmitter IC 102 along the signaling path 107. The forwarding counter 114 is used to track the count of data forwarded from the buffer circuit 108, at 206. The receiver logic 115 monitors the forwarded data count and generates the acknowledge (“Ack”) control signal for transfer to the transmitter IC 102 via the backchannel 109 as the forward data count reaches a certain threshold level, for example, 64 bytes. As the “Ack” signal is received at the transmitter IC 102, a corresponding count is decremented from the transmit count to determine the buffer storage availability.

During the incremental mode of operation, as data is transmitted to the receiver IC 104 from the transmitter IC 102, the control signal provides a straightforward indicator each time available space in the buffer opens up (each control signal representing one or more granular chunks of forwarded data) of the capacity available in the buffer circuit 108 so that it can be monitored, at 208. This is accomplished through straightforward calculations by knowing the total buffer capacity, the amount of data transmitted, and the amount of data forwarded. For example, where a given buffer has a capacity of 1024 kbytes, and the transmit count indicates 996 kbytes transmitted (less the count of forwarded data), the remaining buffer availability is 128 kbytes. With knowledge of the available buffer capacity, the data rate may be appropriately controlled to optimize the data transfer rate and minimize buffer overflows.

In certain circumstances, errors may occur in the acknowledge control bit through a noisy backchannel or the like. Thus, when certain conditions are detected, at 210, such as a threshold number of acknowledge bit signal errors, the system enters a second or “synchronization” mode of operation to reset or synchronize the information concerning the buffer capacity between the transmitter and receiver, at 212. Other threshold events that may be employed in various embodiments include a determination that the buffer has insufficient capacity over a predefined time interval, or detection of a timeout event. FIG. 2b sets forth further detailed steps relating to the synchronization mode. The transmitter integrated circuit communicates with the receiver integrated circuit to switch modes by sending a mode select bit or other control signal along the signaling path at 214.

Referring to FIGS. 2b and 4, the synchronization mode takes advantage of the various transmit, receive and forwarding counts that were generated during the incremental mode. Once the threshold event is detected, and the mode selection control signal sent, the accumulated transmit count is sent along the signaling path 107 to the receiver IC 104, and fed to the receiver logic 115, at step 216. The receiver logic 115 evaluates the current transmit count and the receive count to determine a count offset, at 218. The offset represents the number of data cells that have been lost since the last synchronization mode cycle. The receive count is then updated based on the transmit count, at 219, and the forwarded data count then reset as well to reflect the compensation based on the offset, at 220.

Further referring to FIGS. 2b and 4, after the compensated forward count is generated, the count value is sent back along the backchannel 109 to the transmitter IC 102, at 222. The count value may be a multi-bit value, but since it is sent only upon the occurrence of the threshold events, the bandwidth impact to normal operation is minimal. With the newly updated forward count at the transmitter IC 102, the transmit logic 111 determines the accurate remaining buffer availability based on the compensated forwarded count, at step 224, through a straightforward calculation of the total buffer capacity less the difference between the transmit count and the compensated forwarded data count. Once the synchronization is complete, the transmit logic 111 generates a mode control signal for transmission to the receiver IC 104, at 226, to return to the incremental mode of operation, and resets the various counters.

Those skilled in the art will appreciate the benefits and advantages afforded by the embodiments described herein. By providing a first mode of operation capable of accurately determining the flow of data through a buffer circuit with minimal bandwidth overhead, overall performance can be maximized. By also providing a second synchronous mode of operation to reset various counters and periodically compensate for lost data packets, the robustness and reliability of the system may be enhanced.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of controlling the flow of data transmitted from a transmitter to a receiver, the method comprising:
in a first mode, calculating an available buffer capacity of a buffer based on buffer output information sent by the receiver to the transmitter;
transmitting data from the transmitter to the receiver at a rate based on the calculated available buffer capacity;
upon detecting a threshold condition, switching to a second mode comprising:
sending transmit data information to the receiver; and
updating the buffer output information based on the transmit data information.

2. The method of claim 1, wherein the buffer output information comprises a control signal generated when a predefined amount of data is forwarded from the buffer.

3. The method of claim 1, wherein the threshold condition is based on at least one from the group comprising:
an error rate in the buffer output information, lack of available buffer capacity for a duration exceeding a threshold duration, or a timeout value.

4. The method of claim 1, and further comprising:
maintaining a transmit count at the transmitter representing the amount of data transmitted to the receiver;
generating a receiver count at the receiver representing the amount of data received at the receiver;
generating a forwarded data count at the receiver representing the amount of data forwarded from the buffer.

5. The method of claim 4, wherein:
in the first mode, a control signal is generated when the forwarded data count reaches a predefined value.

6. The method of claim 4, wherein:
in the second mode, the transmit count is sent as the transmit data information to the receiver, the receiver count is compared to the transmit count, and an offset is determined that represents an amount of lost data.

7. The method of claim 6, wherein:
the updating of the buffer output information includes applying the offset to the forwarded data count value to compensate for the lost data.

8. The method of claim 7, and further comprising:
feeding the updated buffer output information back to the transmitter; and
determining the available buffer capacity based on the updated buffer output information.

9. The method of claim 1, and further comprising:
switching back to the first mode following the updating of the buffer output information.

10. A device comprising:
a receiver operable to receive data from a transmitter;
a buffer to temporarily store the received data;
a receive counter operable to generate a receive data count value representing an amount of the received data;
a forward counter operable to generate a forwarded data count value representing an amount of the forwarded data outputted by the buffer;
wherein in a first mode, a flow of data through the buffer is controlled by generating a control signal based on the forwarded data count value, and sending the control signal back to the transmitter; and
wherein in a second mode, a flow of data through the buffer is controlled by receiving a transmit count from the transmitter, updating the receive data count value and the forwarded data count value based on the transmit count, and sending the updated forwarded data count value back to the transmitter.

11. The device of claim 10, further comprising:
logic operative to compare the transmit count to the receive data count value and determine an offset value representing lost data, wherein the updating is based on the offset value.

12. The device of claim 11 wherein the transmitter and the receiver are independent integrated circuit devices.

13. The device of claim 12 wherein the transmitter and the receiver are in a peer-to-peer data network.

14. The device of claim 12 wherein the transmitter is directly coupled to the receiver.

15. The integrated circuit device of claim 11 wherein the logic is responsive to a control signal from the transmitter to switch to a different mode.

16. A channel flow control system comprising:
means for calculating available buffer capacity in a first mode based on buffer output information sent by a receiver to a transmitter;
means for transmitting data from the transmitter to the receiver at a rate based on the calculated available buffer capacity;
means for detecting a threshold condition;
means for sending transmit data information to the receiver in a second mode upon detecting a threshold condition; and
means for updating the buffer output information based on the transmit data information.
